(19) United States
(12) Patent Application Publication
(10) Pub. No.: US 2006/0077238 A1
(43) Pub. Date: Apr. 13, 2006

(54) Ink reservoir for an inkjet printing mechanism

(76) Inventors: Darrell Mann, Hong Kong (HK); Wai Chan, Hong Kong (HK)

Correspondence Address: JACOBSON HOLMAN PLLC, 400 SEVENTH STREET N.W., SUITE 600, WASHINGTON, DC, 20004, US

(21) Appl. No.: 10/962,750

(22) Filed: Oct. 13, 2004

(51) Int. Cl. B41J 2/175

(52) U.S. Cl. 347/85

(57) ABSTRACT

An ink container for supplying ink to an inkjet print head includes a reservoir for storing the ink, and the reservoir has an outlet. The container further includes a plurality of non-porous particles placed inside the reservoir at least at two different spacings from adjacent particles for controlling a capillary pressure inside the reservoir.

### BACKGROUND

1. Field of the Invention

The present invention relates to inkjet printing technologies, and more specifically to ink containers, which retain and provide controlled release of ink from the ink containers.

2. Background of the Invention

An inkjet printing apparatus, such as an inkjet printer or copying machine, frequently uses an inkjet print head mounted within a carriage that is moved back and forth across a print medium, such as paper. As the print head is moved across the print medium, a control system activates the print head to fire or eject ink droplets onto the print medium to form images and text. Ink is provided to the print head by a supply of ink that is either carried by the carriage or mounted to the printing system not to move with the carriage.

For the case where the ink supply is not carried with the carriage, the ink supply can be in continuous fluid communication with the print head by the use of a conduit to replenish the print head continuously. Alternatively, the print head can be intermittently connected with the ink supply by positioning the print head proximate to a filling station that facilitates connection of the print head to the ink supply.

For the case where the ink supply is carried with the carriage, ink supply may be integral with the print head, whereupon the entire print head and ink supply is replaced when ink is exhausted. Alternatively, the ink supply can be carried with the carriage and be separately replaceable from the print head. For the case where the ink supply is separately replaceable, the ink supply is replaced when exhausted, and the print head is replaced at the end of print head life. Regardless of where the ink supply is located within the printing system, it is critical that the ink supply provide a reliable supply of ink to the inkjet print head.

In addition to providing ink to the inkjet print head, the ink supply frequently provides additional functions within the printing system, such as maintaining a negative pressure, frequently referred to as a backpressure, within the ink supply and inkjet print head. This negative pressure must be sufficient so that a head pressure associated with the ink supply is kept at a value that is lower than the atmospheric pressure to prevent leakage of ink from either the ink supply or the inkjet print head frequently referred to as drooling. The ink supply is required to provide a negative pressure or back pressure over a wide range of temperatures and atmospheric pressures in which the inkjet printer experiences in storage and operation.

One negative pressure generating mechanism that has previously been used is a porous member, such as an ink-absorbing member, which generates a capillary force inside the ink supply. Once such ink absorbing member is a reticulated polyurethane foam which is discussed in U.S. Pat. No. 4,771,295, entitled “Thermal Inkjet Pen Body Construction Having Improved Ink Storage and Feed Capability” to Baker, et al., issued Sep. 13, 1988, and assigned to Hewlett-Packard Company.

To achieve stable ink ejection, it is desirable to adequately control the ink capillary pressure within the ink supply as the ink level within the ink supply falls during consumption of the ink. U.S. Pat. No. 5,488,401, entitled “Ink-Jet Recording Apparatus and Ink Tank Cartridge Thereof,” issued Jan. 30, 1996 and assigned to Seiko Epson Corporation, discloses a foam inserted into the ink container to be differentially compressed such that the foam has differently sized pores within the ink supply. In this way, different capillary pressures generated by the differently sized pores are available within the ink supply. However, such a design may not adequately and/or predictably control the capillary pressure within the ink supply. This may adversely affect control of the ink ejection, which is very desirable for inkjet printing apparatus.

### OBJECT OF THE INVENTION

Therefore, it is an object of the present invention to provide an improved ink container for an inkjet printing apparatus, which may have a more consistent and predictable control of the capillary pressure inside the container, or at least provide the public with a useful choice.

### SUMMARY OF THE INVENTION

According to an aspect of the present invention, an ink container for supplying ink to an inkjet print head includes a reservoir for storing the ink, and the reservoir has an outlet. The container further includes a plurality of non-porous particles placed inside the reservoir at least at two different spacings from adjacent particles for controlling a capillary pressure inside the reservoir.

According to another aspect of the present invention, an inkjet printer includes
a print head, through which ink drops can be fired onto a print medium during printing operations; and
an ink container for supplying ink to the inkjet print head, wherein the ink container includes
   a reservoir for storing the ink, including an outlet; and
   a plurality of non-porous particles placed inside the reservoir at least at two different spacings from adjacent particles for controlling a capillary pressure inside the reservoir.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

FIG. 1 is an exemplary embodiment of an inkjet printer, in which an exemplary ink container of the present invention can be used;

FIG. 2 is a schematic representation of the exemplary ink container of the present invention and an inkjet print head that receives ink from the ink container to accomplish printing;

FIG. 3 is a cross-sectional view of a first embodiment of the ink container of the present invention;

FIG. 4 is a cross-sectional view of a second embodiment of the ink container of the present invention;

FIG. 5 is a cross-sectional view of a third embodiment of the ink container of the present invention;

FIG. 6 illustrates various configurations of particles that can be used in the exemplary ink containers of FIGS. 3-5; and

FIG. 7 illustrates various shaped particles that can be used in the exemplary ink containers of FIGS. 3-5.

### DETAILED DESCRIPTION

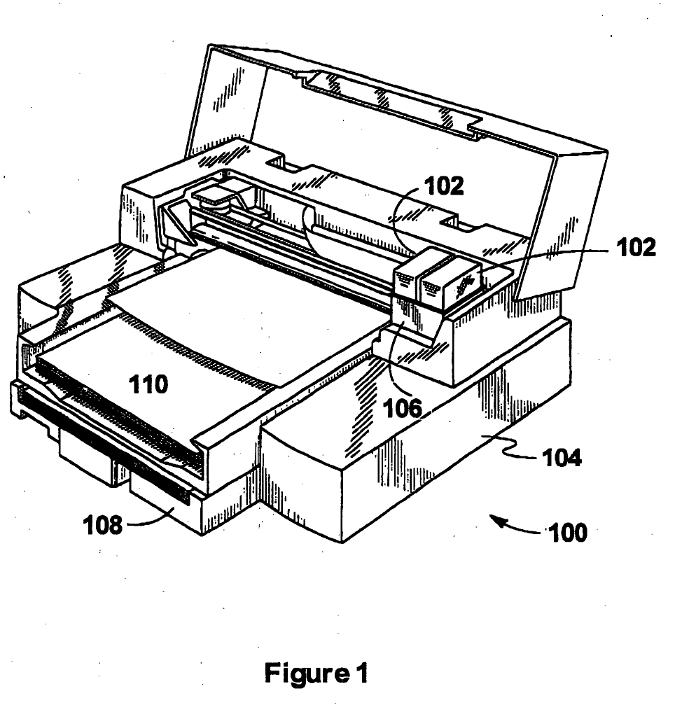

FIG. 1 is a perspective view of one exemplary embodiment of a printing system 100, shown with its cover open, that includes at least one ink container 102 of the present invention. The printing system 100 further includes at least one inkjet print head (not shown) installed in the printer portion 104. The inkjet print head is responsive to an activation signal from the printer portion 104 to eject ink. The inkjet print head is replenished with ink by the ink container 102.

The inkjet print head is preferably installed in a scanning carriage 106 and moved relative to a print media as shown in FIG. 1. Alternatively, the inkjet print head is fixed and the print media is moved past the print head to accomplish printing. The inkjet printer portion 104 includes a media tray 108 for receiving print media 110. As print media 110 is stepped through the print zone, the scanning carriage moves the print head relative to the print media 110. The printer portion 104 selectively activates the print head to deposit ink on the print media to thereby accomplish printing.

The printing system 100 shown in FIG. 1 is shown with two replaceable ink containers 102 representing an ink container 102 for black ink and a three-color partitioned ink container 102 containing cyan, magenta, and yellow inks, allowing for printing with four colorants. The method and apparatus of the present invention is applicable to printing systems 100 that make use of other arrangements such as printing systems that use greater or less than four-ink colors, such as in high fidelity printing which typically uses six or more colors.

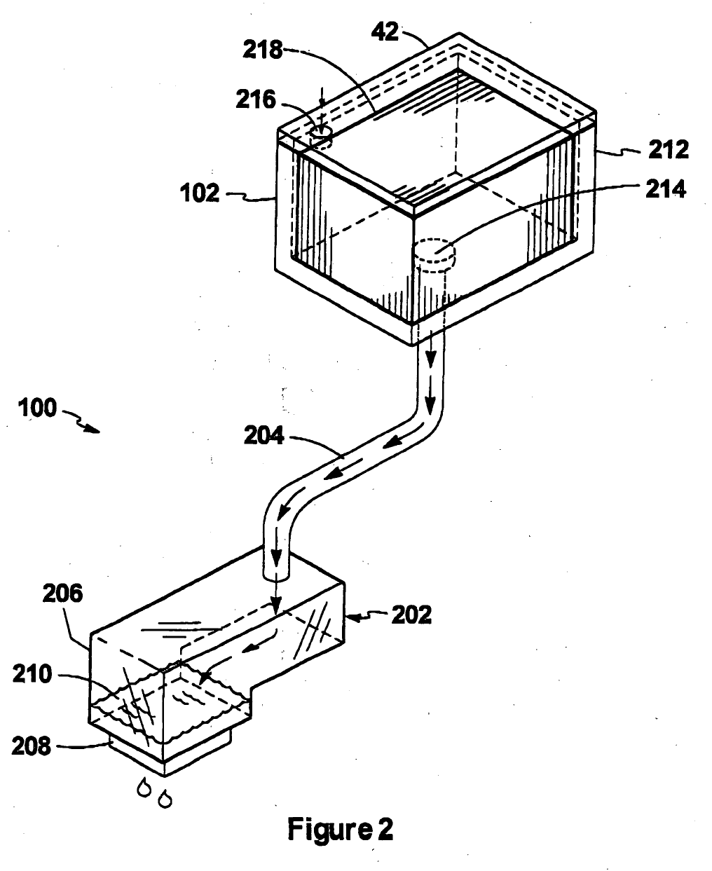

FIG. 2 is a schematic representation of the printing system 100, which includes the ink supply or ink container 102, an inkjet print head 202, and a fluid interconnect 204 for fluidically interconnecting the ink container 102 and the print head 202.

The print head 202 includes a housing 206 and an ink ejection portion 208. The ink ejection portion 208 is responsive to activation signals by the printer portion 104 for ejecting ink to accomplish printing. The housing 206 defines a small ink, reservoir for containing ink 210 that is used by the ejection portion 208 for ejecting ink. As the inkjet print head 202 ejects ink or depletes the ink 210 stored in the housing 206, the ink container 102 replenishes the print head 202. A volume of ink contained in the ink supply 102 is typically significantly larger than a volume of ink container within the housing 206. Therefore, the ink container 102 is a primary supply of ink for the print head 206.

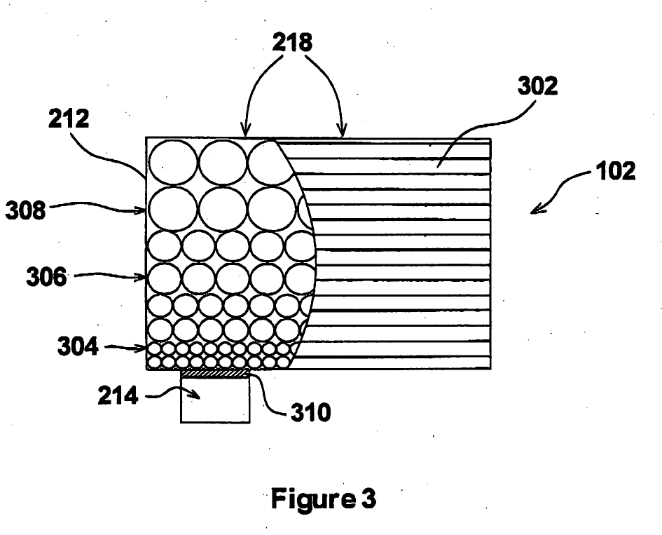

The ink container 102 includes a reservoir 212 having a fluid outlet or exit 214 and an air inlet 216. Disposed within the reservoir 212 is a capillary storage member generally indicated as 218, which will be discussed in details with reference to FIGS. 3-7. The capillary storage member 218 performs several important functions within the inkjet printing system 100. The capillary storage member 218 must have sufficient capillarity to retain ink to prevent ink leakage from the reservoir 212 during insertion and removal of the ink container 102 from the printing system 100. This capillary force must be sufficiently great to prevent ink leakage from the ink reservoir 212 over a wide variety of environmental conditions such as temperature and pressure changes. The capillary should be sufficient to retain ink within the ink container 102 for all orientations of the reservoir 212 as well as undergoing shock and vibration that the ink container 102 may undergo during handling.

Once the ink container 102 is installed into the printing system 100 and coupled to the print head by way of fluid interconnect 204, the capillary storage member 218 should allow ink to flow from the ink container 102 to the inkjet print head 202. As the inkjet print head 202 ejects ink from the ejection portion 208, a negative gauge pressure, sometimes referred to as a backpressure, is created in the print head 202. This negative gauge pressure Within the print head 202 should be sufficient to overcome the capillary force retaining ink within the capillary member 218, thereby allowing ink to flow from the ink container 102 into the print head 202 until equilibrium is reached. Once equilibrium is reached and the gauge pressure within the print head 202 is equal to the capillary force retaining ink within the ink container 102, ink no longer flows from the ink container 102 to the print head 202. The gauge pressure in the print head 202 will generally depend on the rate of ink ejection from the ink ejection portion 208. As the printing rate or ink ejection rate increases, the gauge pressure within the print head will become more negative causing ink to flow at a higher rate to the print head 202 from the ink container 102. In one preferred inkjet printing system 100 the print head 202 produces a maximum backpressure that is equal to 100 inches of water or a negative gauge pressure that is equal to 10 inches of water.

The print head 202 can have a regulation device included therein for compensation for environmental changes such as temperature and pressure variations. If these variations are not compensated for, then uncontrolled leaking of ink from the print head ejection portion 208 can occur. In some configurations of the printing system 100 the print head 202 does not include a regulation device, instead the capillary member 218 is used to maintain a negative backpressure in the print head 202 over normal pressure and temperature excursions. The capillary force of the capillary member 40 tends to pull ink back to the capillary member, thereby creating a slight negative backpressure within the print head 202. This slightly negative backpressure tends to prevent ink from leaking or drooling from the ejection portion 208 during changes in atmospheric conditions such as pressure changes and temperature changes. The capillary member 218 should provide sufficient backpressure or negative gauge pressure in the print head 202 to prevent drooling during normal storage and operating conditions.

FIG. 3 illustrates an exemplary embodiment of the ink container 102 of the present invention. The capillary storage member 218 has two parts, namely, a foam member 302 and a plurality of differently sized non-porous balls 304, 306, 308. Preferably, the size of the particles is within a range of 0.01-1 mm in diameter. The foam member 302, which is placed at one side inside the reservoir 212, can be the traditional type of foam as generally understood by the people in the art. It is noted that the foam member 302 is not overlapped with the exit 214 to reduce its effect on the ink flow through the exit 214. The balls 304, 306, 308 are placed at the other side inside the reservoir 212 and atop a filter 310 at the exit, which filter functions to prevent the balls falling through the exit 214. The balls, more specifically, the gaps or the intervals between adjacent balls, are to generate the capillary pressure inside the reservoir 212 as can be understood by the people in the art. Furthermore, as can be appreciated by the people in the art, the greater the gaps, the smaller the capillary pressure thereby generated. Vice versa. In the exemplary embodiment of FIG. 3, the balls 304 closer to the exit 214 generally have a smaller size as compared to the balls 308 away from the exit 214. Thus, the balls 304 closer to the exit 214 generally have smaller gaps between adjacent balls and thereby generate higher capillary pressures as compared to the balls 308 away from the exit 214. By controlling the gaps between the adjacent balls, control of the capillary pressures inside the reservoir can be achieved. In the exemplary embodiment of FIG. 3, control of the gaps is achieved by providing balls of different sizes in accordance with their distances from the exit 214. Since the ball sizes as well as the gaps between adjacent balls can be controlled appropriately and predictably, the capillary pressures inside the reservoir can also be controlled in a more consistent and predictable manner as compared to conventional designs. It can be understood that such control can be achieved in various ways such as by using differently shaped particles.

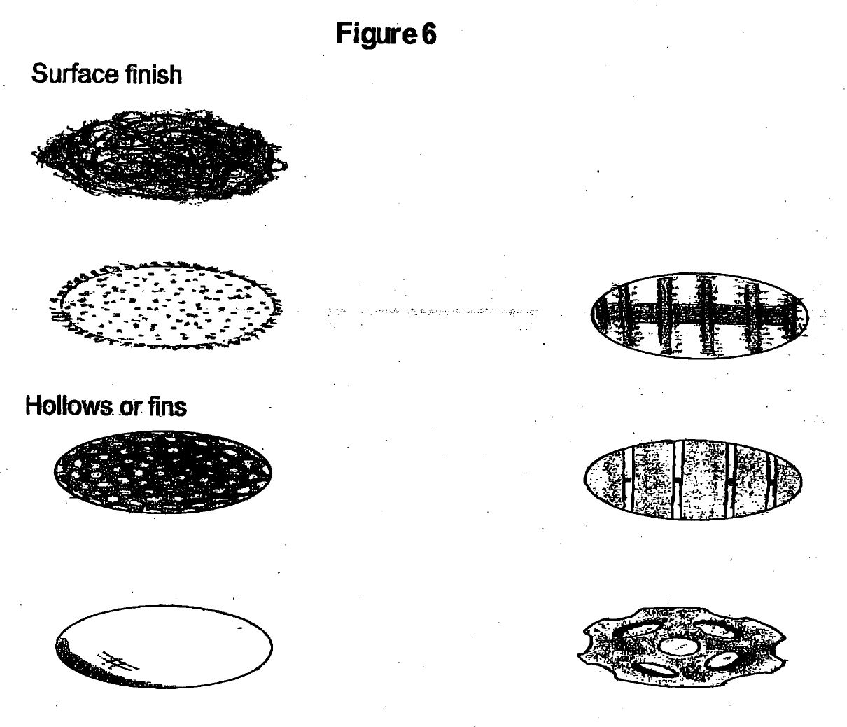

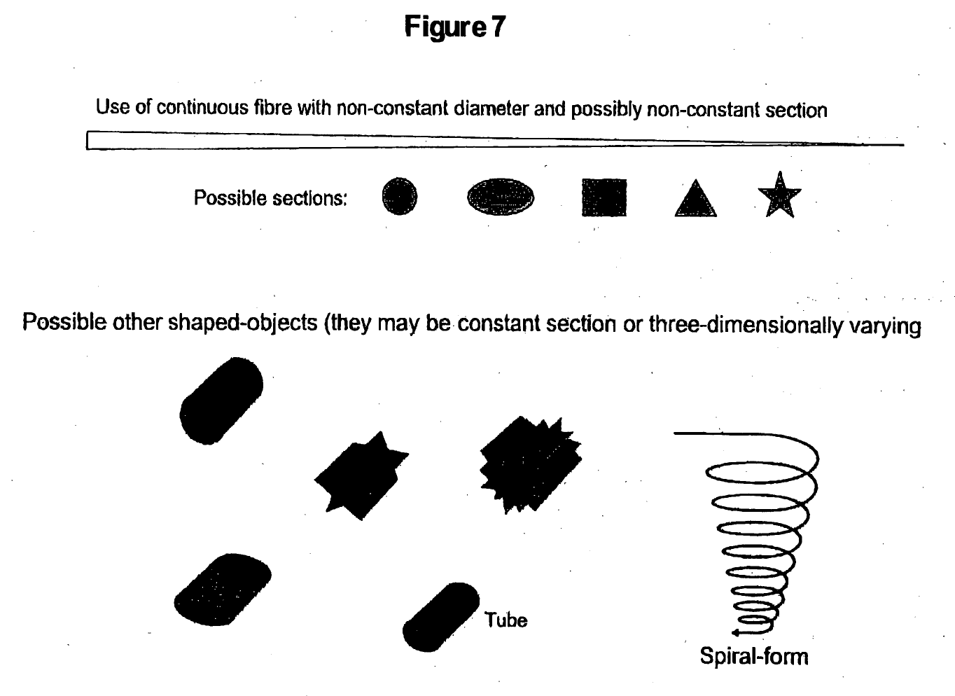

Various shaped non-porous particles can be used as shown in FIG. 7, such as cylinders, hollow tubes, ovoid, spirals or any other three-dimensional shapes that are capable of creating inter-particle gaps when they are brought into close proximity with one another. In addition, the particles can be hollow or multi-hollow, contain at least one surface groove or depression, contain at least one protruding element, be formed by winding at least one continuous fiber into a substantially ball shape, or be a combination of the above mentioned features, which are shown in FIG. 6. Furthermore, when the particles and the foam are incorporated into the reservoir 212 of the ink container 102, both can be compressed to a certain extent such that the particles may retain their position during transport and/or operation of the container.

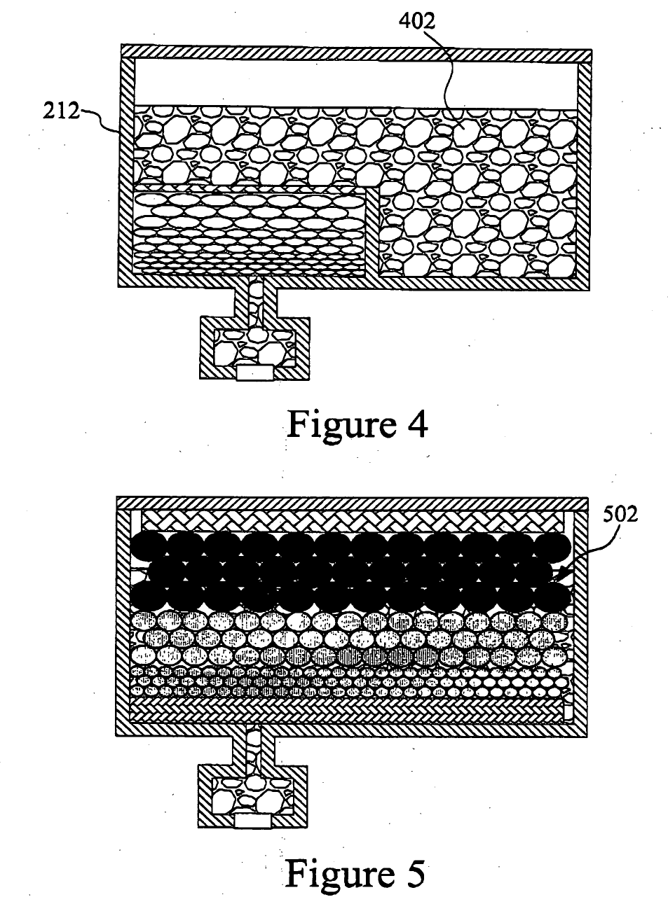

FIG. 4 illustrates a second embodiment of the container, in which the foam member 402 takes more space inside the reservoir 212 as compared to the embodiment of FIG. 3. Another embodiment is shown in FIG. 5, in which the capillary storage member 218 is purely composed of differently sized balls 502.

What is claimed is:

1. An ink container for supplying ink to an inkjet print head, comprising:
a reservoir for storing the ink, including an outlet; and
a plurality of non-porous particles placed inside the reservoir at least at two different spacings from adjacent particles for controlling a capillary pressure inside the reservoir.

2. The ink container of claim 1, wherein the plurality of particles includes at least a first and a second group of particles placed at a first and a second spacing respectively.

3. The ink container of claim 2, wherein the ink can be supplied from the reservoir through the outlet towards the print head.

4. The ink container of claim 3, wherein the first spacing is smaller than the second spacing such that the capillary pressure generated by a gap of between adjacent particles of the first group is greater than the one of the second group, and wherein the first group of particles is closer to the outlet than the second group of particles.

5. The ink container of claim 4, wherein the first and second groups of particles are substantially of a first and a second average size respectively, and wherein the first and second sizes are different.

6. The ink container of claim 4, wherein the first group of particles is generally of a smaller size than the second group.

7. The ink container of claim 4, wherein the size of the particles is within a range of 0.01-1 mm diameter.

8. The ink container of claim 1, wherein the particles are of three dimensional shape that is capable of creating inter-particle gaps when they are brought into close proximity with one another.

9. The ink container of claim 8, wherein a substantial portion of the particles are substantially spherical.

10. The ink container of claim 8, wherein a substantial portion of the particles are asymmetrically shaped.

11. The ink container of claim 1, wherein the particles are compressed to a predetermined extent when they are enclosed inside the reservoir such that they can be retained in their positions.

12. The ink container of claim 1, wherein the particles are made from a material with adaptive properties such that as the level of ink in the reservoir changes, the volume of the particles remains at least substantially constant so as to maintain a constant capillary pressure on the remaining ink inside the reservoir.

13. The ink container of claim 1, further comprising a flexible joining member for joining the particles.

14. An inkjet printer, comprising
a print head, through which ink drops can be fired onto a print medium during printing operations; and
an ink container for supplying ink to the inkjet print head, wherein the ink container includes
a reservoir for storing the ink, including an outlet; and
a plurality of non-porous particles placed inside the reservoir at least at two different spacings from adjacent particles for controlling a capillary pressure inside the reservoir.
